(19) United States
(12) Patent Application Publication
(10) Pub. No.: US 2020/0385628 A1
(43) Pub. Date: Dec. 10, 2020

(54) BIO-DERIVED COMPLEX FOR OIL AND GAS WELL REMEDIATION

(71) Applicant: Richard Strother, (US)

(72) Inventors: Richard Strother, Palm Beach, FL (US); Jeffrey Loch, Celebration, FL (US); Robert Stepan, Strongsville, OH (US)

(73) Assignee: Richard Strother, Palm Beach, FL (US)

(21) Appl. No.: 16/863,838

(22) Filed: Apr. 30, 2020

Related U.S. Application Data
(60) Provisional application No. 62/920,478, filed on May 1, 2019.

(51) Int. Cl. C09K 8/524; C09K 8/528

(52) U.S. Cl. CPC C09K 8/524; C09K 2208/10; C09K 8/528

(57) ABSTRACT

The present invention relates to a composition and a method for oil and gas well remediation by the creation and use of a bio-derived nano scale complex mixtures, comprising bio-derived solvents and/or surfactants that allows the breaking, dissolving, dispersing and caging of obstructions in oil and gas wells. The invention further reduces the well obstructions to a free-flowing fluid and then encapsulates them in an electrochemical, spherical, globe of protection for removal.

### CROSS-REFERENCE TO RELATED APPLICATIONS

This non-provisional application claims priority to and the benefit of provisional application 62/920,478, filed Apr. 30, 2019. The entire disclosure of the above-identified application is incorporated herein by reference.

Some references, which may include patents, patent applications, and various publications, are cited and discussed in the description of the present disclosure. The citation and/or discussion of such references is provided merely to clarify the description of the present disclosure and is not an admission that any such reference is “prior art” to the present disclosure described herein. All references cited and discussed in this specification are incorporated herein by reference in their entireties and to the same extent as if each reference was individually incorporated by reference.

### FIELD OF THE INVENTION

The present invention relates to a bio-derived nano scale complex and a method for oil and gas well remediation, intervention, well stimulation in well services or well work, both on shore and off-shore as well as well head maintenance and any operation carried out on an oil or gas well during or at the end of its productive life that alters the state of the well or well geometry. The nano scale complex comprises various combinations of bio surfactants, bio solvents and organic acids.

### BACKGROUND OF THE INVENTION

Petroleum, for past many years, has been recovered from subterranean reservoirs through the use of drilled wells and production equipment. Oil and natural gas are found in, and produced from, porous and permeable subterranean formations, or reservoirs. The porosity and permeability of the formation determine its ability to store hydrocarbons, and the facility with which the hydrocarbons can be extracted from the formation. Generally, the life cycle of an oil and/or gas well includes drilling to form a wellbore, casing, cementing, stimulation, and enhanced or improved oil recovery.

In today's world of well maintenance and remediation, conventional matrix acid stimulation is used, wherein conventional acids are pumped into the formation at or below the fracturing pressure and is useful for both sandstone and carbonate reservoirs. The most common acid used is hydrochloric acid (HCl), injected at a typical concentration of 15 wt. %, but can be as high as 28 wt %. However, in high temperature applications, HCl does not produce acceptable stimulation results due to its fast reaction that leads to lack of penetration. As a matter of fact, the reaction is so rapid in high temperatures that it is impossible for the acid to penetrate more than a few inches into the formation. In addition, HCl will not dissolve quartz and alumina silicates found in sandstone reservoirs as these particles (fines) migrate into the pores of the near-wellbore area and can reduce production. Furthermore, acidizing in sandstone reservoirs can create re-precipitation of reaction products that may cause new formation damage.

U.S. Pat. No. 6,399,547 discloses a well treatment fluid comprising hydrochloric acid; water; an aliphatic aldehyde having 1-10 carbon atoms; and an aromatic aldehyde having 7-20 carbon atoms.

Further in prior conventional art, well remediation and well stimulation, the recovery of gas and oil, especially heavy crude oil, the resulting challenges were the high viscosity and vapor pockets. These challenges attenuate the delivery of heavy crude and causes lower yields. The standard remedy is to pump kerosene and/or light oil down to the clogged area. In addition, hexane, toluene, xylene and alcohols are used to mitigate the problem. The down part is that these chemicals are harmful, toxic and damaging to the environment. In addition, these chemicals are very expensive and require special handling. Further to this problem, these materials are not exceptionally effective and can result in a high cost for improved production/oil & gas recovery.

Accordingly, to overcome the disadvantages of the prior art, the present invention discloses innovative technology to alter either the rock permeability or the fluid viscosity in order to produce the oil at commercially competitive rates. In addition to low permeability, it addresses low API and high oil viscosity. Moreover, the biodegradable “green” nature of the invention is environmentally friendly and poses no risk to contamination of underground aquifers or drinking water tables.

The non-corrosive invention is safe and non-toxic, containing no volatile organic compounds (“VOCs”), versus toxic level VOCs, deadly chemicals and heavy aromatic distillates that corrode well casing in conventional methodology and persists contaminating the environment with long half-lives. In addition, there is no need for Hazmat Gear, booms and evacuation pumps that conventional methodology requires. The invention is therefore more cost-effective in addition to being environmentally friendly.

### BRIEF DESCRIPTION OF THE DRAWINGS

FIG. 1 shows a flowchart for the bases that contribute to one of the embodiments of the present invention.

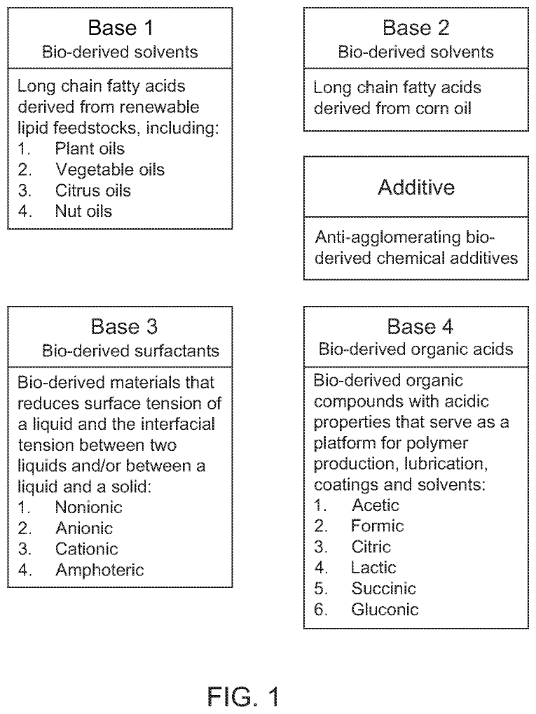

FIG. 2 shows a pictorial view of the method of dissolving, dispersing and caging for removal of obstructions in the well according to the present invention.

FIG. 3 shows a flowchart methodology for introducing the interrelation of the biodegradable ingredients according to the present invention.

### SUMMARY OF INVENTION

The present invention relates to an environment friendly composition and method for oil and gas well remediation by creation and use of bio-derived nano scale complex mixtures, including bio-derived/biodegradable solvents and/or surfactants and/or organic acids.

The nano scale complex is present in a new physio-chemical structure of high thermal stability and chemistry. The complex comprises a mixture of bio-derived solvents which are combined with anti-agglomerating compounds and a variety of surfactants.

In an embodiment, the bio-derived solvents comprise a mixture of fatty acids, wherein the fatty acids are organic carboxylic acids with long aliphatic chains. The fatty acids are saturated (containing only C—C single bonds) fatty acids or unsaturated fatty acids (containing multiple bonds between carbon atoms).

In an embodiment, the surfactant is a bio-derived anionic, and/or nonionic, and/or cationic and/or amphoteric surfactant.

In another embodiment, the anti-agglomerating compounds are selected from unsaturated methyl esters, unsaturated di-substituted amides.

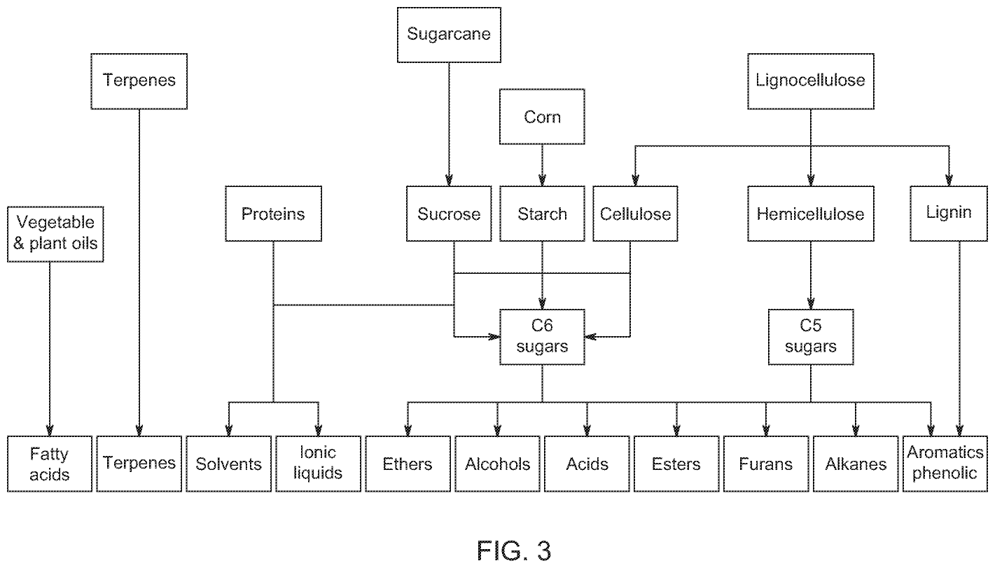

The invention further relates to a method of well stimulation comprising breaking, dissolving, dispersing and caging of obstructions in wells comprising the nano scale complex. The bio-derived readily biodegradable nano scale complex mixtures are formulated in 11 steps as set forth in FIG. 3 to allow the breaking and dissolving any high molecular weight organic matter.

The long lasting nano scale complex has a high flash point and retains heat, allowing the product to penetrate beyond the perforations and deep into the formation to repair it without creating new damage, dissolve obstructions, expand/extend the pores, improve permeability (water wet the formation), reduce surface and interfacial tension, to prevent emulsions and to ultimately increase production, thus avoiding the many complex and environmental issues resulting from the usage of toxic acids, including HCl.

### DETAILED DESCRIPTION

The present invention discloses compositions and methods for oil and gas well remediation by the creation and use of non-conventional bio-derived nano scale complex mixtures, including bio-derived solvents and/or surfactants that allow the breaking, dissolving, dispersing and caging of obstructions in oil and gas wells, pipeline storage and mixing facilities. The bio-derived readily biodegradable nano scale complex mixtures are formulated to allow the breaking and dissolving of any high molecular weight organic matter.

For convenience, certain terms employed in the specification, examples, and appended claims are listed here. However, phraseology and terminology employed herein is for purpose of description and should not be regarded as limiting and one of ordinary skill in the art, given the present specification, would be capable of making and using the presently claimed and disclosed invention in a broad and non-limiting manner.

‘Stimulation’ refers to the removal of unwanted deposits from the wellbore and production equipment.

‘Well stimulation’ refers to a well intervention performed on an oil or gas well to increase production by improving the flow of hydrocarbons from the drainage area into the well bore.

‘Well remediation’ refers to the treatment of geological formations to improve the recovery of hydrocarbons from well damage and arterial blockage caused by the precipitation and deposition of heavy organic molecules from petroleum fluids.

‘Well(s)’ refers to oil and gas wells, pipeline storage and mixing facilities.

‘Nano scale complex’ refers to a water-in-oil (W/O), oil-in-water (O/W) and other classes of nano-emulsions which have been found beneficial in drilling, completion, well remediation and other oil and gas industry related operations.

‘Surfactants’ refers to ‘surface-active agents’ which are molecules that contain a hydrophilic, or “water-loving” end, and a hydrophobic, or “water-fearing” end.

‘Asphaltenes’ refers to aromatic-based hydrocarbons of amorphous structure. They are present in crude oils in the form of colloidally dispersed particles. They deposit in near wellbore subterranean formations, in well tubing and perforations, and in transfer lines, storage tanks, surface equipment, pipelines hinder production and transport of high asphaltenic crudes from wells.

The nano scale complex of present invention comprises a mixture of fatty acids combined with anti-agglomerating compounds and a variety of bio-derived surfactants and organic acids.

The fatty acids are saturated or unsaturated fatty acids; wherein saturated fatty acids are selected from, but not limited to, palmitic acid, stearic acid etc. and unsaturated fatty acids are selected from, but not limited to, oleic acid, linoleic acid, erucic acid, linolenic acid etc.

The fatty acids are derived from (1) vegetable oils and plant oils including corn, canola, soybean, palm, coconut, safflower, sunflower, rapeseed, cottonseed, and rice oils, (2) nut oils, including peanut, almond, beech, brazil, cashew, hazelnut, macadamia, pecan, pine nut, pistachio, pumpkin seed, and walnut oils; and (3) citrus oils, including lemon, lime and orange oils.

The anti-agglomerating compounds are selected from unsaturated methyl esters, unsaturated di-substituted amides or combinations thereof. The methyl ester and amides act as a solvent and dissolver in well remediation.

The bio-derived surfactants are anionic, nonionic, cationic or amphoteric or combinations thereof. The bio-derived surfactants further include (a) nonionic ethoxylates, alkoxylates and cocamides; (b) anionic compounds, including linear alkyl-benzene sulfonates, alpha-olefin sulfonates and alcohol ether sulfates; (c) cationic compounds; and (d) amphoteric compounds or derivatives thereof.

The bio-derived surfactants reduce the surface tension of a liquid and the interfacial tension between two liquids and/or between a liquid and a solid.

The bio-derived organic acids are selected from, but not limited to, acetic, formic, citric, lactic, succinic and gluconic acids. These bio-derived organic compounds with acidic properties serve as a platform for polymer production, lubrication, coatings and solvents.

In one of the embodiments, the nano scale complex further may optionally comprise one or more of terpenes, furans, ethers, alcohols, alkanes, aromatic phenolics. The terpenes are large and diverse organic compounds with strong aromatics. The furans, ethers, alcohols, alkanes and aromatic phenolics are well-known organic compounds.

The bio-derived nano scale complex mixtures are formulated in 11 steps as set forth in FIG. 3 to allow the breaking and dissolving any high molecular weight organic matter, which can be applied by one of ordinary skill in the art.

The invention further relates to a method of gas and oil well remediation comprising the step of:

(a) Dissolving: The invention employs a versatile, broad range molecule in specifically engineered compositions that break down the aromatics, paraffin and asphaltene—literally exploding them apart. This complementary, complex, composition of a bio-derived solvent, surfactant and potent surface acting agent(s) all work in concert to melt and reduce the contaminants to their lowest energy form—a sphere. As part of the naturally occurring separation, the larger spheres gather together in suspension from the smaller spheres.

(b) Dispersing: At this point, due to the electrostatic action of the free energy surface acting agent, the collection of spheres begins flowing. The negative attractions of these agents keep the undesirable spheres from agglomerating while they are swept away from the perforations. The flowing spheres gravitate towards the positive attraction of cages which are composed of sub-micron particles.

(c) Caging: Much like a paperclip that is attracted to a magnet, the flowing spheres of dissolved obstructions become “locked” in a spherical globe of electrochemical protection. These segregated and now harmless cages of hard mineral salts such as calcium, magnesium and other contaminants which are swept to the surface of the well for disposal.

Moreover, the present invention dissolves obstructions, disperses them into nanoparticles, cages them electrostatically, meanwhile acting in the 24 hour soaking, the perforations and oil reservoir, lubricating them mostly with vegetable oil, then removing or vacuuming the solution into a baker truck for disposal before the well is reopened. Meanwhile, the casing is lubricated by a combination of bio surfactants.

The present invention is, especially, formulated to treat specific precipitation obstructions such as asphaltenes, paraffin and scale within and near the wellbore resulting into improved permeability, shrinked clay swelling, removal of soil film on rocks, restoring of water wet pores and diluting and deconstructing long chain impeding molecules.

The invention further stimulates producing wells of sandstone deposits, carbonate reservoirs and heavy and extra-heavy oil deposits. It is useful in cleaning production pipes and removal of damage in gas fields.

The powerful invention takes solid chemical obstructions in oil and gas wells as well as related transport, blending, and storage facilities and quickly reduces the obstructions to a free-flowing fluid and encapsulating them in an electrochemical, spherical, globe of protection. The sub-micron particles are then corralled, extracted and disposed of, leaving a lubricated casing surface for increased flow and output of crude oil or gas.

Thermal stable methods are used to allow production of exceedingly viscous oil. Such hydrocarbons are called viscous or “heavy oil” as the methods of present invention retain heat, dissolve the obstructions, penetrate deep into the formation and are able to deconstruct the long carbon chains (C:60-C:80) such as asphaltenes. Moreover, the biodegradable “green” nature of the invention is environmentally friendly and poses no risk to contamination of underground aquifers or drinking water tables. Moreover, the invention is “Green” in that it is made from bio-derived, degradable, renewable natural materials with no volatile organic compounds (VOC), no CO₂ emissions and no Hazmats protocols normally used in well treatment. It is environmentally friendly and represents no hazard to drinking water tables as it is injected underground into the wells.

According to an embodiment of the invention, the viscosity of heavy crudes with low API's and inoperable transport viscosity can be increased and thus enabling the use of methods of transport heretofore unavailable to such heavy crudes.

In one of the embodiments, once an oil well is vetted for its length, volume and capacity, as well as the well's type of reservoir formation of sand or rock or clays by one of ordinary skill in the art, a balanced composition according to the present invention, i.e. biodegradable and “Green” solvent, surfactant product of nano-particles, is poured down the well bore in order to enhance oil recovery from seasoned oil wells which are under-producing due to obstructions and lack of mobility in the reservoirs.

In another embodiment, organic obstructions (incrustations) such as wax, paraffins, asphaltenes and dirt are formed over time in production pipes, diminishing their diameter, restricting oil flow and in oil reservoirs, restricting pores and channels, causing oil to reduce its movement and flow, consequently diminishing well production. Then, nano scale complex mixtures invade organic obstructions in well production pipes and in oil reservoirs, dissolving them into a free flowing liquid. Once pores and channels in reservoirs are cleaned, they are also coated so that they cannot easily form incrustations again and this allows oil to flow freely, increasing pressure, permeability and mobility while reducing viscosity, all of which increases oil mobility and can restore oil well production back to its historical “peaks”. In essence, it reinvigorates oil reservoirs. The nano scale complex penetrates much deeper into oil reservoirs, lasting many times longer than the currently hazardous toxic, acid and corrosive injection solvents used in the prior art.

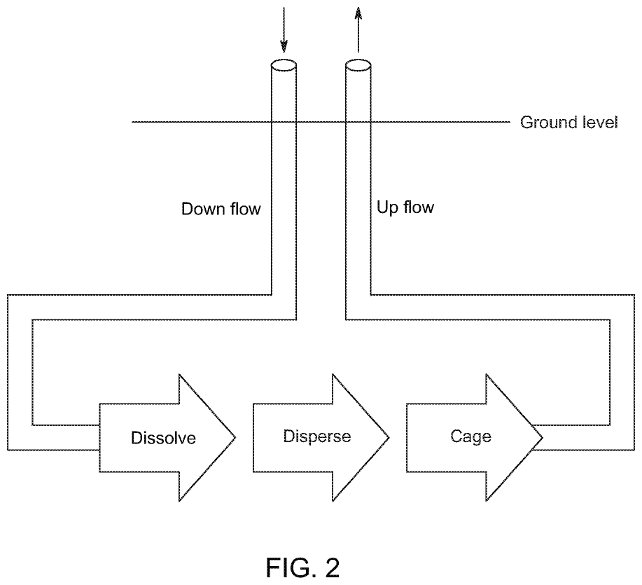

The obstructions are dissolved, caged and dispersed (as shown in FIG. 2) and are vacuumed up with the fluids and placed in a holding tank for removal. The well is then put back into service.

In one of the embodiments, the present invention provides a biodegradable nanotechnology fully adjusted to environmental regulations, recovery of the production potential of oil and gas producing wells, cleaning and removal of fillers and incrustations in production pipes, lengthening and improving the useful life of the well.

In a further embodiment, the nano scale complex that penetrate deep between heavy asphalt and ground earth to efficiently lower the viscosity increases dramatically the yield of heavy organic oil products and also the break up and solubilization of the heavy crude. Additionally, a especially reactive biodegradable organic oil derivative is used in the process that works by penetrating the adhesion between the heavy crude and the ground. The process chemically reacts with the heavy crude to form bio-derived surfactants in situ. As a result, this increases the ability of the water-based invention to lower the adhesion, surface tension and resulting friction of the heavy crude leads to a more flowable extractable product.

Heavy Crudes with low API's and inoperable transport viscosity can be combined with certain aspects of the invention to increase viscosity and thus be able to use pipelines or other methods of transport unavailable to heavy crudes with low viscosity and tar-like qualities.

These and other aspects of the present invention will be further appreciated upon consideration of the following Example(s), which are intended to illustrate certain particular embodiments of the invention but are not intended to limit its scope, as defined by the claims.

### Example 1

### Mobility Enhancement Test

The experimental and core conditions are shown in Table 1 to reflect the enhancement in mobility by performing mobility change tests within the porous medium.

TABLE 1

| Core Conditions | | Experimental Conditions | | | |
|---|---|---|---|---|---|
| Core type | BEREA | Pore pressure (psi) | 700 | | |
| Sand | UN - | Confinement pressure | 1000 | | |
| | consolidated (psi) | | | | |
| Porosity (%) | 20 | Transducer calibration | 500 | Initial | Final |
| | | (psi) | | Differential | Differential |
| Permeability (mD) | 1000 | Temperature (F.) | 150 | (%) | (%) |
| Depth (pies) | | Overbalance pressure | | 6.9 | 5.5 |
| | | (psi) | | | |
| Well | PJS05 | Mud injected pressure | | 6.9 | 5.4 |
| | | (psi) | | | |
| Porous volume | 20 | Pressure level of plaster | | 6 | 5.4 |
| (cc) | | (psi) | | | |
| Length (cm) | 6 | Injection rate (cc/min) | 1 | 6.8 | 5.3 |
| Diameter (cm) | 3.753 | Fluid 1 (cc) | | 6.7 | 5.3 |
| Area (cm²) | 11.784 | Fluid 1 (cc) | | | |
| | | Fluid 2 (cc) | | | |
| | | Fluid 3 (cc) | | | |

Observations

| | |
|---|---|
| Differ. Initial Pressure (psi): 33.5 | Differ. Pressure Final (psi): 26.5 |
| Initial Mobility (md/cp): 3.723 | Mobility Final (md/cp): 5.100 |
| % Damage to the Formation: −31.01% | % Return to Permeability: 131.01% |

### Results

The composition of the present invention takes solid obstructions and quickly reduces them to a free flowing liquid. The sub-micron particles are corralled and then encapsulated in an electrochemical, spherical globe of protection. In other words, the present invention use electrochemical principles to bring sustainable productivity and good health to the well. Hence, the assortment of products provides full range effectiveness from hard inorganics that would naturally agglomerate and remove them from the well.

### CONCLUSION

The results obtained during the tests of mobility within the porous medium, with radial displacement methodology in core subjected to equivalent pore pressure and simulation temperature gave affirmative results, since the fluid system is of direct emulsion type with high physicochemical stability, creates an obvious reaction of ultra-low interfacial tensions, and the incorporation of broad molecular chain organic systems such as heavy and extra heavy crudes, which induces physico-chemically to perform an early stimulation inside and outside the porous medium, which translates into a modification of its mobility, or increase in the speed of displacement of crude oil, within the porous medium, which brings a benefit action at the level of immediate production of the wells treated with the present invention, which is characterized by an electrochemical modification of the system creating a double electric layer by the presence of a mix of surfactants of various natures, which couples in organic modules of long chains, shielding the natural feature inside and outside; wherein the reservoir creates a bridge inside in the petro physics of the deposit, and outside of it, in the innate crude itself of formation.

1. A bio-derived nano scale complex for well remediation comprising:
a first solvent derived from a vegetable oil(s);
a second solvent comprising an anti-agglomerating additive;
a bio-surfactant(s); and
an organic acid(s);
wherein the nano scale complex deconstructs a compound(s) with long carbon chains and consequently lowers down the well oil viscosity.

2. The bio-derived nano scale complex of claim 1, wherein the first solvent is selected from saturated or unsaturated fatty acids.

3. The first solvent of claim 2, wherein the saturated fatty acids are selected from palmitic acid, stearic acid.

4. The first solvent of claim 2, wherein the unsaturated fatty acids are selected from oleic acid, linoleic acid, erucic acid, linolenic acid.

5. The bio-derived nano scale complex of claim 1, wherein the second solvent is derived from a bio-based feedstock.

6. The bio-derived nano scale complex of claim 1, wherein the anti-agglomerating additive is selected from unsaturated methyl esters, unsaturated di-substituted amides.

7. The bio-derived nano scale complex of claim 1, wherein the bio-surfactants are selected from anionic, nonionic, cationic, amphoteric or combinations thereof.

8. The bio-derived nano scale complex of claim 1; wherein the bio-surfactants are selected from ethoxylates, alkoxylates, cocamides, linear alkyl-benzene sulfonates, alpha-olefin sulfonates, alcohol ether sulfates or derivatives thereof.

8.-20. (canceled)

21. The bio-derived nano scale complex of claim 1, wherein the organic acids are selected from acetic acid, formic acid, citric acid, lactic acid, succinic acid, gluconic acid or combinations thereof.

22. The bio-derived nano scale complex of claim 1, wherein the compound(s) with long carbon chains is high molecular weight organic matter selected from paraffin, asphaltene, scales, mud cake, emulsion and retrograde condensation from open-hole perforations and formation of sandstone and carbonate reservoirs.

23. A method comprising:
(a) Dissolving and breaking down of a compound with long carbon chain to their lowest energy form, a sphere, using a bio-derived solvent(s) and a bio-surfactant(s);
(b) Dispersing, wherein a two-step process comprises (i) flowing of a collection of spheres due to an electrostatic action of the free energy bio-surfactant(s); and (ii) keeping undesirable spheres from agglomerating by negative attractions of the free energy bio-surfactant(s), while the spheres are swept away from the well perforations;
(c) Caging the flowing spheres of dissolved obstructions to lock and segregate in a spherical globe of electrochemical protection; and sweeping the segregated cages of hard mineral salts such as calcium, magnesium and other contaminants to the surface of the well for disposal;
wherein said method results in removal of obstructions in a well.

24. The method of claim 23, wherein the compound with long carbon chain is high molecular weight organic matter selected from paraffin, asphaltene.

25. The method of claim 23, wherein the bio-derived solvent comprises a first solvent derived from vegetable oils.

26. The method of claim 23, wherein the bio-derived solvent comprises a second solvent, an anti-agglomerating additive.

27. The method of claim 23, wherein the first solvent is selected from saturated fatty acids or unsaturated fatty acids.

28. The method of claim 23, wherein the saturated fatty acids are selected from palmitic acid, stearic acid.

29. The method of claim 23, wherein the unsaturated fatty acids are selected from oleic acid, linoleic acid, erucic acid, linolenic acid.

30. The method of claim 23, wherein the second solvent is derived from a bio-based feedstock.

31. The method of claim 23, wherein the anti-agglomerating additive is selected from unsaturated methyl esters, unsaturated di-substituted amides.

32. The method of claim 23, wherein the bio-surfactant is selected from anionic, nonionic, cationic, amphoteric or combinations thereof.
